(19) United States
(12) Patent Application Publication
(10) Pub. No.: US 2018/0265805 A1
(43) Pub. Date: Sep. 20, 2018

(54) RELEASE OF ODORIFEROUS SUBSTANCES FROM MICROCAPSULES

(71) Applicant: Henkel AG & Co. KGaA, Duesseldorf (DE)

(72) Inventors: Thomas Gerke, Duesseldorf (DE); Christian Kropf, Hilden (DE); Ursula Huchel, Cologne (DE); Thomas J. J. Mueller, Duesseldorf (DE); Julian Papadopoulos, Duesseldorf (DE)

(21) Appl. No.: 15/761,123

(22) PCT Filed: Aug. 25, 2016
(86) PCT No.: PCT/EP2016/070067

§ 371 Date: Mar. 19, 2018

(30) Foreign Application Priority Data
Sep. 18, 2015 (DE) 10 2015 217 983.4

(51) Int. Cl. C11B 9/00; B01J 13/22

(52) U.S. Cl. CPC C11B 9/0076; B01J 13/22; C11B 9/0003

(57) ABSTRACT

The present invention relates to the controlled release of odoriferous substances from microcapsules by means of orthoformic acid esters. As a result, a long-lasting fragrance is achieved.

### CROSS-REFERENCE TO RELATED APPLICATIONS

The present application is a national stage entry according to 35 U.S.C. § 371 of PCT Application No. PCT/EP2016/070067 filed on Aug. 25, 2016, which claims priority to German Patent Application No. 10 2015 217 983.4, filed on Sep. 18, 2015; both of which are herein incorporated by reference in their entirety.

### TECHNICAL FIELD

The subject matter herein generally relates to the release of odorants from microcapsules. This makes possible a long-lasting experience of fragrance.

### BACKGROUND

The consumer is confronted with fragrances in various aspects of daily life. One of the problems associated with this is that the intensity of the odor of the corresponding compounds declines relatively quickly on account of the high volatility of said compounds. Furthermore, some fragrances cannot be incorporated into the application products in a stable manner.

Washing or cleaning agents, cosmetic agents and also, for example, adhesives generally contain, for example, fragrances that impart a pleasant odor to the agents. The fragrances mask the odor of other ingredients, thus giving the user a pleasant impression in terms of odor.

Furthermore, washing agents and cosmetic agents contain fragrances that ensure that the laundry or a person's body has a pleasant fragrance. In the field of washing agents, it is intended for not only damp, but also dry laundry to have a fresh fragrance which lasts as long as possible. However, fragrances are generally highly volatile substances, and therefore it is difficult to produce a long-lasting effect of fragrance. In particular in the case of fragrances that produce the fresh, light notes of the perfume and evaporate particularly quickly due to their relatively high vapor pressure, it is difficult to achieve the desired long-lasting impression of fragrance.

The prior art describes pro-fragrance molecules (pro-fragrances). These are one option for releasing fragrances in a delayed manner. Depending on the chemical structure of the molecule, the bound fragrance is released by the effect of radiation, heat or reaction with chemical substances. This may take place, for example, as a result of a covalent bond in the pro-fragrance molecule being broken. However, in the case of known pro-fragrance molecules, the fragrance intensity is low, and the obtained fragrance effect has only a short duration. Further, a both immediate and delayed release of the fragrances is not possible using said pro-fragrance molecules. Therefore, there is a need for pro-fragrance molecules that can release fragrances both immediately and in a delayed manner over a longer period of time.

It is also known in the prior art to introduce additives into washing agents. Said additives are introduced into the washing agent in the form of microcapsules. During the wash, the microcapsules are deposited on the textile to be cleaned, and can then be released, for example, during use of the textile, either diffusively or by friction (breakage of the capsules when the textile is used or worn). The use of microcapsules improves the performance of the additives in comparison with directly introducing the additive into the washing agent, in particular if the capsule surface is of such a quality that said surface has a larger affinity to the substrate, the item of clothing or the textile than does the additive itself.

### SUMMARY

According to a non-limiting embodiment, microcapsules may have a core and a shell where the core comprises a compound of general formula (I)

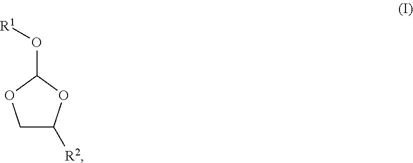

where
R¹ and R² are each selected, independently of one another, from a linear, aliphatic, olefinic or open-chain organic group having from 2 to 20 carbon atoms and having from 0 to 10 heteroatoms selected from N, O, S, and Si; a branched or cyclic organic group having from 3 to 20 carbon atoms and having from 0 to 10 heteroatoms selected from N, O, S, and Si; an aromatic or heteroaromatic organic group having from 4 to 20 carbon atoms and having from 0 to 10 heteroatoms selected from N, O, S, and Si.

According to another non-limiting embodiment, the microcapsules may include the compound where the compound may be, but is not limited to, a washing agent, a cleaning agent, a cosmetic agent, and combinations thereof

According to yet another non-limiting embodiment of a method, a method may include applying the microcapsules having Formula (I) to at least one surface to be fragranced, heating the microcapsules to a temperature ranging from about 20 C to about 250 C and/or bringing the microcapsules into contact with a Lewis acid and/or a Bronsted acid.

### DETAILED DESCRIPTION

Surprisingly, it has been found that, when particular pro-fragrance molecules are used, the fragrances are released from the capsules even under particular and thus controlled conditions. This makes it possible to release a fragrance in a controlled manner over a longer period of time, and therefore a pleasant and fresh fragrance remains even over a longer period of time.

In a first embodiment, microcapsules may include a core and a shell, wherein the core has a compound of general formula (I)

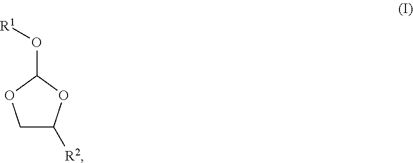

wherein
R¹ and R² each consist, independently of one another, of a linear, aliphatic, olefinic or open-chain organic group having 2 to 20 carbon atoms, in particular 2 to 12 carbon atoms, and having 0 to 10 heteroatoms selected from N, O, S and Si; a branched or cyclic organic group having 3 to 20 carbon atoms, in particular 3 to 12 carbon atoms, and having 0 to 10 heteroatoms selected from N, O, S and Si; an aromatic or heteroaromatic organic group having 4 to 20 carbon atoms, in particular 4 to 12 carbon atoms, and having 0 to 10 heteroatoms selected from N, O, S and Si;

As used herein, the terms “capsules” and “microcapsules” are used synonymously in the present application. The capsules have a core and a shell, and therefore in the following the term “core/shell capsule” is also used. Suitable microcapsules are capsules which have an average diameter X_{50.3} (volume average) of from 1 to 100 μm, alternatively from 1 to 80 μm, particularly alternatively from 1 to 50 μm, and in particular from 1 to 40 μm. The average particle size diameter X_{50.3} is determined by sieving or by means of a Camsizer particle size analyzer from Retsch.

Core/shell capsules, as used herein, are capsules which have, as an outer shell, a wall material that is solid at room temperature. The compound of the above-shown general formula (I) is located in the core. Said compound is a pro-fragrance. It is also possible for a plurality of different compounds of the above-shown general formula (I) to be contained. The core may either be solid, or be liquid or viscous. Wax-like structures are also conceivable. It is possible for the at least one pro-fragrance (compound of the above-shown general formula (I)) to be contained in the capsule substantially as a pure substance. Alternatively, capsules are also conceivable in which the core comprises, in addition to the at least one pro-fragrance, further ingredients, such as solvents, stabilizers or also further odorants or olfactorily active substances, etc. The capsules may be liquid, viscous or at least meltable at temperatures of 120° C. or less, in particular 80° C. and less, particularly 40° C. and less, in a non-limiting embodiment. This makes it possible to provide the pro-fragrance, specifically a compound of the above-shown general formula (I) in the core of the capsule, at the desired time, and makes it possible for said pro-fragrance to be uniformly distributed in the core.

The core comprises the pro-fragrance (compound of general formula (I)) in a proportion of from 0.001 to 50 wt. %, in particular from 0.05 to 45 wt. %, particularly from 0.1 to 40 wt. %, alternatively from 1 to 38 wt. % or from 5 to 35 wt. %, particularly alternatively from 5 to 30 wt. %, based on the total weight of the core. It has been shown that more pro-fragrance does not lead to a considerably longer experience of fragrance, since the capsule is completely emptied when the shell is broken open. When lower amounts are used, the experience of fragrance is no longer clearly noticeable enough to people that they perceive it to be favorable.

The compounds of general formula (I) are pro-fragrances. If corresponding compounds are exposed to heat, in particular in a temperature range of from 20° C. to 250° C., alternatively from 20° C. to 90° C., the stored fragrance is released together with CO₂. The fragrance is also released, together with the formation of CO₂, upon contact with a Lewis acid and/or Bronsted acid, alternatively with a Bronsted acid.

Surprisingly, it has been demonstrated that, upon exposure to heat and/or upon contact of the compound of the above-shown general formula (I) with a Lewis acid and/or a Bronsted acid, a fragrance is released from said compound. CO₂ is produced at the same time. The shell of the microcapsules is not permeable to CO₂. This results in an increase in pressure inside the microcapsules. If a particular pressure is exceeded, the capsule bursts, thus releasing the material of the core. In the microcapsules, the fragrance that has been produced as a result of CO₂ splitting off from the compound of the above-shown general formula (I) is released, thus allowing a long-lasting experience of fragrance.

Advantageously, a force of from 0.1 mN to 5 mN, in particular from 0.2 mN to 3 mN, alternatively from 0.5 mN to 2 mN, is required to cause the capsules to burst.

In a likewise non-limiting embodiment, the capsules are not thermally stable. If the capsules are exposed to a temperature of at least 70° C., alternatively at least 60° C., alternatively at least 50° C., and in particular at least 40° C., the compound of the above-shown general formula (I), which is located inside the capsules, is released. The fragrance stored in the compound of the above-shown general formula (I) is released in particular in a temperature range of from 20° C. to 250° C., alternatively from 20° C. to 90° C. In this temperature range, not only are the components contained in the core therefore released, but the stored fragrance is also released at the same time.

The capsules that can be used are water-insoluble capsules. The water-insolubility of the capsules has the advantage that said capsules are thus able to outlast the washing or cleaning process and are thus capable of releasing the pro-fragrance only after the water-based washing or cleaning process, for example during drying as a result of a mere increase in temperature or as a result of exposure to sunlight when clothing is worn or when the surface is subject to friction.

In particular, the water-insoluble capsules may be capsules in which the wall material (shell) contains polyurethanes, polyolefins, polyamides, polyacrylates, polyesters, polysaccharides, epoxy resins, silicone resins and/or polycondensation products of carbonyl compounds and compounds containing NH groups, such as melamine-/urea-/formaldehyde capsules or melamine-/formaldehyde capsules or urea-/formaldehyde capsules.

In a non-limiting embodiment, the capsules are capsules that can be frictionally opened. The term “capsules that can be frictionally opened” means capsules which, if they adhere to a surface treated therewith, can be opened or frictionally opened by means of mechanical friction or pressure such that the contents are released only as a result of a mechanical effect, for example if a towel on which capsules of this kind are deposited is used to dry the hands. The shell of the capsules that surrounds the core or (filled) cavity has an average thickness in the range of from around 0.01 to 5 μm, alternatively from around 0.05 μm to approximately 3 μm, in particular from around 0.05 μm to approximately 1.5 μm, alternatively from approximately 80 nm to 150 nm, in particular from 90 nm to 120 nm. Capsules can in particular be effectively frictionally opened if they are within the above-indicated ranges with respect to the average diameter and with respect to the average thickness.

Possible materials for the capsules are typically high-molecular compounds, such as protein compounds (for example, gelatine, albumin, casein and others), cellulose derivatives (for example, methyl cellulose, ethyl cellulose, cellulose acetate, cellulose nitrate, carboxymethyl cellulose and others) and especially also synthetic polymers, for example polyamides, polyethylene glycols, polyurethanes, polyacrylates, epoxy resins and others). Melamine-/urea-/formaldehyde or melamine-/formaldehyde or urea-/formaldehyde or polyacrylate copolymer, for example, are used as the wall material (shell). In a non-limiting embodiment, capsules of this kind are used as they are described in US 2003/0125222 A1, DE 10 2008 051 799 A1 or WO 01/49817.

Non-limiting melamine-/formaldehyde microcapsules are produced by condensing melamine-/formaldehyde precondensates and/or C₁-C₄ alkyl ethers thereof in water in which a hydrophobic material is emulsified that comprises at least one odorant and optionally further ingredients, e.g. at least one oil, in the presence of a protective colloid. A hydrophobic material that can be used in the core material (inter alia, as an additive) for production includes all types of oils, such as odorants, plant oils, animal oils, mineral oils, paraffins, silicone oils and other synthetic oils. Suitable protective colloids are e.g. cellulose derivatives, such as hydroxyethyl cellulose, carboxymethyl cellulose and methyl cellulose, polyvinyl pyrrolidone, copolymers of N-vinylpyrrolidone, polyvinyl alcohols, partially hydrolyzed polyvinyl acetates, gelatine, gum arabic, xanthan gum, alginates, pectins, degraded starches, casein, polyacrylic acid, polymethacrylic acid, copolymers of acrylic acid and methacrylic acid, water-soluble polymers, containing sulfonic acid groups, having a content of sulfoethyl acrylate, sulfoethyl methacrylate or sulfopropyl methacrylate, and polymers of N-(sulfoethyl)-maleinimide, 2-acrylamido-2-alkylsulfonic acids, styrene sulfonic acids and formaldehyde, and condensates of phenol sulfonic acids and formaldehyde.

In at least a non-limiting embodiment, the used microcapsules may be coated, over part of or the whole surface thereof, with at least one cationic polymer. Accordingly, a suitable cationic polymer for coating the microcapsules is at least one cationic polymer from polyquaternium-1, polyquaternium-2, polyquaternium-4, polyquaternium-5, polyquaternium-6, polyquaternium-7, polyquaternium-8, polyquaternium-9, polyquaternium-10, polyquaternium-11, polyquaternium-12, polyquaternium-13, polyquaternium-14, polyquaternium-15,polyquaternium-16, polyquaternium-17, polyquaternium-18, polyquaternium-19, polyquaternium-20, polyquaternium-22, polyquaternium-24, polyquaternium-27, polyquaternium-28, polyquaternium-29, polyquaternium-30, polyquaternium-31, polyquaternium-32, polyquaternium-33, polyquaternium-34, polyquaternium-35, polyquaternium-36, polyquaternium-37, polyquaternium-39, polyquaternium-43, polyquaternium-44, polyquaternium-45, polyquaternium-46, polyquaternium-47, polyquaternium-48, polyquaternium-49, polyquaternium-50, polyquaternium-51, polyquaternium-56, polyquaternium-57, polyquaternium-61, polyquaternium-69, polyquaternium-86. Polyquaternium-7 may be used in a non-limiting embodiment. The polyquaternium nomenclature of the cationic polymers used within the scope of this application is taken from the declaration of cationic polymers according to the International Nomenclature of Cosmetic Ingredients (INCI declaration).

Core/shell capsules may have a shell comprising a wall material selected from melamine-/urea-/formaldehyde or melamine-/formaldehyde or urea-/formaldehyde or polyacrylate copolymer. It has been shown that in particular capsules of this kind do not allow CO₂ to be diffused that is produced when fragrances are released from compounds of general formula (I). Rather, pressure builds up inside the microcapsules, and as a result said microcapsules are destroyed as of a particular threshold value.

If the microcapsules are part of a washing or cleaning agent, said microcapsules may also be present in the form of microcapsule granules. In order to obtain a microcapsule granulate, the microcapsules are brought into contact with a particulate carrier material. As used herein, carrier materials are materials that have a very good absorption property. The carrier material has an oil-absorption capacity according to ISO 787-5 of at least 125 ml/100 g, alternatively at least 150 ml/100 g, particularly alternatively at least 175 ml/100 g, and in particular at least 200 ml/100 g. The oil-absorption capacity is used as a measure for the absorption properties of a material. Said measure is expressed in milliliters of oil per 100 g of the sample. For determination, a sample amount of the particulate material to be examined is placed on a plate. From a burette, refined linseed oil is slowly dropped in, and is rubbed into the particulate material using a measuring spatula after each addition of the oil. Oil continues to be added until clusters of solid and oil have formed. From this time onwards, only one drop of refined linseed oil is added at a time, and is thoroughly dispersed using the measuring spatula after each addition of the oil. When a soft paste is formed, the addition of oil is stopped. The paste should be barely spreading out, but without splitting or crumbling and also still adhering to the plate.

Non-limiting microcapsule granules therefore contain carrier material loaded with microcapsules, wherein the carrier material having an oil-absorption capacity according to ISO 787-5 of at least 125 ml/100 g, alternatively at least 150 ml/100 g, particularly alternatively at least 175 ml/100 g, and in particular at least 200 ml/100 g. The oil-absorption coefficient of the pure carrier material before being loaded with microcapsules is determined as was described previously.

As used herein, the particulate carrier material may be a single particulate component or a mixture of a plurality of different components. What is important is that the sum of all carrier materials, after one hour of heating in the dry state, has an oil-absorption capacity of 100 ml/100 g or more.

The BET surface according to DIN ISO 9277 2003-05 of the carrier material is, independently of the values for the oil-absorption capacity, alternatively at least 10 m²/g, alternatively at least 40 m²/g, in particular at least 70 m²/g, particularly at least 100 m²/g, and alternatively at least 130 m²/g.

The average particle size X_{50.3} of the carrier material is below 100 mm, alternatively below 75 mm, alternatively below 50 mm, alternatively below 25 mm, in particular below 18 mm, and in particular below 10 mm.

The carrier material comprises amorphous aluminosilicates. These are understood to be amorphous compounds having various proportions of aluminum oxide (Al₂O₃) and silicon dioxide (SiO₂) that contain further metals. The amorphous aluminosilicate used in the method can be described by one of the following formulae (I) or (II):

x(M₂O)Al₂O₃y(SiO₂)w(H₂O) (Formula I)

x(MeO)y(M₂O)Al₂O₃z(SiO₂)w(H₂O) (Formula II)

In formula (I), M represents an alkali metal, such as sodium or potassium. Particularly, x attains values of from 0.2 to 2.0, y attains values of from 0.5 to 10.0, and w attains all positive values including 0.

In formula (II), Me represents an alkaline earth metal, and M represents an alkali metal, and preferably, x represents values of from 0.001 to 0.1, y represents values of from 0.2 to 2.0, z represents values of from 0.5 to 10.0, and w represents positive values including 0.

Furthermore, the carrier material may, comprise instead of the amorphous aluminosilicates or in addition to these clays, such as bentonites, alkaline earth metal silicates, e.g. calcium silicate, alkaline earth metal carbonates, in particular calcium carbonate and/or magnesium carbonate and or silicic acid.

Silicic acids are contained in the carrier material, the term “silicic acid” being a collective term for compounds of general formula (SiO₂)ₘ.nH₂O. Precipitated silicic acids are produced from an aqueous alkali silicate solution by precipitation using mineral acids. In the process, colloidal primary particles form which agglomerate as the reaction progresses and eventually grow into aggregates. The powder-like, voluminous shapes have BET surfaces of from 30 to 800 m²/g.

The term “pyrogenic silicic acids” groups together microdispersed silicic acids which are produced by flame hydrolysis. In the process, silicon tetrachloride decomposes in an oxyhydrogen flame. Pyrogenic silicic acids have, on the surface thereof, considerably fewer OH groups than precipitated silicic acids. On account of their hydrophilic properties, caused by the silanol groups, the synthetic silicic acids are frequently subject to chemical post-treatment methods in which the OH groups react, for example, with organic chlorosilanes. As a result, modified, for example hydrophobic, surfaces arise which considerably widen the application-specific properties of the silicic acids. Chemically modified silicic acids are also covered by the term “silicic acids”.

Particularly advantageous embodiments are Sipernat 22 S, Sipernat 50 or Sipernat® 50 S from Evonik (Germany), namely spray-dried and subsequently in particular milled silicic acids, since these have been proven to be very absorptive. The other silicic acids known from the prior art are, however, also used.

Corresponding microcapsule granules are thoroughly described in WO 2010/118959 A1. Express reference is made to the method for producing corresponding granules, described in said document in particular starting on page 12.

In a non-limiting embodiment, a plurality of different pro-fragrances, i.e. at least one pro-fragrance, may also be contained in the core of a microcapsule.

“At least one”, “leastwise one” or “one or more”, as used herein, refers to 1 or more, for example 2, 3, 4, 5, 6, 7, 8, 9 or more. In connection with components of the compound described herein, this statement refers not to the absolute quantity of molecules, but rather to the type of component. “At least one compound of formula (I)” therefore means, for example, one or more different compounds of formula (I), i.e. one or more different types of compounds. Together with stated amounts, the stated amounts refer to the total amount of the correspondingly designated type of component, as defined above.

In various embodiments, le of the pro-fragrance of formula (I) contains 1, 2, 3 or 4 heteroatoms selected from O, S, N and Si, in particular with the proviso that the group R¹ contains at least one carbon atom per heteroatom.

In various further embodiments, the group R² also contains 1, 2, 3 or 4 heteroatoms selected from O, S, N and Si, in particular with the proviso that the group R² contains at least one carbon atom per heteroatom.

In various embodiments, R¹ and R² are selected, independently of one another, from the group consisting of substituted or unsubstituted, linear or branched alkyl, alkenyl or alkynyl having up to 20, alternatively up to 12, carbon atoms, substituted or unsubstituted, linear or branched heteroalkyl, heteroalkenyl or heteroalkynyl having up to 20, alternatively up to 12, carbon atoms, and having 1 to 6, alternatively 1 to 4, heteroatoms selected from O, S and N, substituted or unsubstituted aryl having up to 20, alternatively up to 12, carbon atoms, substituted or unsubstituted heteroaryl having up to 20, alternatively up to 12, carbon atoms, and having 1 to 6, alternatively 1 to 4, heteroatoms selected from O, S and N, cycloalkyl or cycloalkenyl having up to 20, alternatively up to 12, carbon atoms, and heterocycloalkyl or heterocycloalkenyl having up to 20, alternatively up to 12, carbon atoms, and having 1 to 6, alternatively 1 to 4, heteroatoms selected from O, S and N.

“Alkyl” refers to a saturated aliphatic hydrocarbon, including straight-chain and branched-chain groups. The alkyl group has 1 to 10 carbon atoms (when a numerical range, e.g. “1 to 10”, is stated herein, this means that this group, in the present case the alkyl group, may have 1 carbon atom, 2 carbon atoms, 3 carbon atoms, etc., up to and including 10 carbon atoms). In particular, the alkyl may be a medium alkyl, having 1 to 6 carbon atoms, or a lower alkyl, having 1 to 4 carbon atoms, e.g. methyl, ethyl, n-propyl, isopropyl, butyl, isobutyl, tert-butyl, etc.

“Alkenyl” refers to an alkyl group, as defined herein, made up of at least two carbon atoms and at least one carbon-to-carbon double bond, e.g. ethenyl, propenyl, butenyl or pentenyl and structural isomers thereof, such as 1- or 2-propenyl, 1-, 2- or 3-butenyl, etc.

“Alkynyl” refers to an alkyl group, as defined herein, made up of at least two carbon atoms and at least one carbon-to-carbon triple bond, e.g. ethynyl (acetylene), propynyl, butynyl or pentynyl and structural isomers thereof as described above.

“Heteroalkyl”, “heteroalkenyl” and “heteroalkynyl”, as used herein, refer to alkyl, alkenyl and alkynyl groups, respectively, as defined above, in which one or more carbon atoms are replaced by heteroatoms, in particular selected from O, S, N and Si, e.g. ethoxyethyl, ethoxyethenyl, isopentoxypropyl, etc.

A “cycloalkyl” group refers to monocyclic, dicyclic or polycyclic groups, in particular made up of 3 to 8 carbon atoms, in which the ring is made up of carbon atoms that are interconnected by carbon-to-carbon single bonds, carbon-to-carbon double bonds and/or carbon-to-carbon triple bonds. The ring may comprise one, two or more or no double and/or triple bonds. However, said ring does not have a complete conjugated pi electron system. For example, a cycloalkyl group is cyclopropyl, cyclobutyl, cyclopentyl, cyclohexyl, cyclobutenyl, cyclopentenyl, cyclohexenyl, etc. Examples of cycloalkyl groups are cyclopropane, cyclobutane, cyclopentane, cyclopentene, cyclohexane, adamantane, cyclohexadiene, cycloheptane and cycloheptatriene.

“Aryl” refers to monocyclic or polycyclic (i.e. rings having shared neighboring carbon atom pairs) groups made up in particular of 6 to 14 carbon ring atoms that have a complete conjugated pi electron system. Examples of aryl groups are phenyl, naphthalenyl and anthracenyl.

A “heteroaryl” group refers to a monocyclic or polycyclic (i.e. rings having a shared neighboring ring atom pair) aromatic ring, made up in particular of 5 to 10 ring atoms, with one, two, three or four ring atoms being nitrogen, oxygen or sulfur, and the remainder being carbon. Examples of heteroaryl groups are pyridyl, pyrrolyl, furyl, thienyl, imidazolyl, oxazolyl, isoxazolyl, thiazolyl, isothiazolyl, pyrazolyl, 1,2,3-triazolyl, 1,2,4-triazolyl, 1,2,3-oxadiazolyl, 1,2,4-oxadiazolyl, 1,2,5-oxadiazolyl, 1,3,4-oxadiazolyl, 1,3,4-triazinyl, 1,2,3-triazinyl, enzofuryl, isobenzofuryl, benzothienyl, benzotriazolyl, isobenzothienyl, indolyl, isoindolyl, 3H-indolyl, benzimidazolyl, benzothiazolyl, benzoxazolyl, quinolizinyl, quinazolinyl, pthalazinyl, quinoxalinyl, cinnolinyl, naphthyridinyl, quinolyl, isoquinolyl, tetrazolyl, 5,6,7,8-tetrahydroquinolyl, 5,6,7,8-tetrahydroisoquinolyl, purinyl, pteridinyl, pyridinyl, pyrimidinyl, carbazolyl, xanthenyl or benzoquinolyl.

A “heterocycloalkyl” group refers to a monocyclic or fused ring made up of 5 to 10 ring atoms, containing one, two or three heteroatoms selected from N, O and S, the remainder of the ring atoms being carbon. A “heterocycloalkenyl” group additionally contains one or more double bonds. However, the ring does not have a complete conjugated pi electron system. Examples of heteroalicyclic groups are pyrrolidine, piperidine, piperazine, morpholine, imidazolidine, tetrahydropyridazine, tetrahydrofuran, thiomorpholine, tetrahydropyridine, and the like.

“Substituted”, as used herein in connection with the substituents and functional groups, means that one or more H atoms are replaced by other functional groups in the group in question, these functional groups being selected in particular from those containing one or more heteroatoms. In various embodiments, the substituents are selected from ═O, ═S, —OH, —SH, —NH₂, —NO₂, —CN, —Br, C₁₋₁₀ alkyl, C₂₋₁₀ alkenyl, C₂₋₁₀ alkynyl, C₃₋₈ cycloalkyl, C₆₋₁₄ aryl, a 5-membered to 10-membered heteroaryl ring in which 1 to 4 ring atoms are independently nitrogen, oxygen or sulfur, and a 5-membered to 10-membered heteroalicyclic ring in which 1 to 3 ring atoms are independently nitrogen, oxygen or sulfur.

In various embodiments, le contains at least one carbonyl group (—C(═O)—) or one aromatic or heteroaromatic group, it being possible for the latter to be substituted, in particular in the alpha position or beta position in relation to the oxygen atom of the orthoester function. In various embodiments, le is therefore a functional group of formula —C(O)—R³, —CH₂—C(O)—R³, aryl, heteroaryl, CH₂ aryl or CH₂ heteroaryl, wherein R³ being selected from the group consisting of hydrogen, substituted or unsubstituted, linear or branched alkyl, alkenyl or alkynyl having up to 20, alternatively up to 10, carbon atoms, substituted or unsubstituted, linear or branched heteroalkyl, heteroalkenyl or heteroalkynyl having up to 20, alternatively up to 10, carbon atoms, and having 1 to 6, alternatively 1 to 4, heteroatoms selected from O, S and N, substituted or unsubstituted aryl having up to 20, alternatively 6 to 10, carbon atoms, substituted or unsubstituted heteroaryl having up to 20, alternatively 4 to 10, carbon atoms, and having 1 to 6, alternatively 1 to 4, heteroatoms selected from O, S and N, cycloalkyl or cycloalkenyl having up to 20, alternatively 5 to 10, carbon atoms, and heterocycloalkyl or heterocycloalkenyl having up to 20, alternatively 4 to 10, carbon atoms, and having 1 to 6, alternatively 1 to 4, heteroatoms selected from O, S and N.

In various embodiments, le is a substituted or unsubstituted, linear or branched alkyl having 1 to 5 carbon atoms, particularly having 1 to 3 carbon atoms, such as methyl or ethyl. In various further embodiments, le is a group of formula —C(O)—R³, and R³ is a substituted or unsubstituted, linear or branched alkyl having up to 5 carbon atoms and alternatively up to 3 carbon atoms, such as methyl.

In various embodiments, le has a molecular weight of up to 300 g/mol, in particular ≤250 g/mol.

In various embodiments of the compound of formula (I), R² is an organic group having 4 to 10 carbon atoms and/or contains at least one, alternatively at least two, more alternatively at least three, heteroatoms selected from N, O, S, Si, F, Cl and Br, and/or contains at least one cyclic group and/or contains at least one carbonyl group (—C(═O)—). In non-limiting embodiments, R² is an organic group having 4 to 10 carbon atoms and contains at least one carbonyl group (—C(═O)—) and optionally at least one further heteroatom selected from N, O and S, in particular O. R² is a group of formula C₁₋₁₀ alkyl-O—(CH₂)ₚ—C(O)O—(CH₂)_{q}—, where p and q are, independently of one another, 0 or an integer from 1 to 6. In various embodiments, R² also has a molecular weight of up to 300 g/mol, in particular ≤250 g/mol.

The group R² of formula (I) is in particular a group derived from a fragrance alkene, and the group le may be in particular a group derived from a fragrance alcohol. “Derived group”, as used in this connection, refers, for example, to the functional group R² that arises if the unsaturated group of a fragrance alkene is added to the orthoformic acid or an orthoformic acid ester, and the two carbon atoms of the double bond form the ring atoms 4 and 5 of the 1,3-dioxolane ring of formula (I). If the fragrance alkene is allyl isoamyl glycolate ((CH₃)₂CH—CH₂—CH₂—O—CH₂—C(O)O—CH₂—CH═CH₂), the group R² would therefore be (CH₃)₂CH—CH₂—CH₂—O—CH₂—C(O)O—CH₂—.

Upon action of a Bronsted and/or Lewis acid, the compound of formula (I) decomposes into the alcohol R¹—OH, which may be a fragrance alcohol, and the carboxylic acid R³—COOH, CO² and the fragrance alkene. All fragrance alkenes or fragrance alcohols that are known in the prior art and are suitable for this purpose may be used.

A “Bronsted acid”, as used herein, is a compound that releases one or more protons (H⁺) and transfers said protons to a reaction partner, or what is referred to as the “Bronsted base”. Any conventional Bronsted acid that is suitable for the purpose may be used. These include, for example, both weak and strong acids, such as formic acid, acetic acid, phosphoric acid or mixtures thereof.

A “Lewis acid”, as used herein, is an electrophilic electron pair acceptor. Any conventional Lewis acid that is suitable for the purpose may be used. These include, for example, some metal cations, but also generally compounds having an incomplete or unstable electron octet.

In various embodiments, the fragrance alkene or fragrance alcohol that is produced from the splitting of the compound of formula (I) is selected from the group consisting of acetovanillone, allyl amyl glycolate, allyl isoamyl glycolate, alpha-amyl cinammyl alcohol, anisyl alcohol, benzoin, benzyl alcohol, benzyl salicylate, 1-butanol, butyl lactate, 2-t-butyl-5-methylphenol, 2-t-butyl-6-methylphenol, carvacrol, carveol, 4-carvomenthenol, cedrol, cetyl alcohol, cinnamic alcohol, citronellol, o-cresol, m-cresol, p-cresol, crotyl alcohol, decahydro-2-naphthol, 1-decanol, 1-decen-3-ol, 9-decen-1-ol, diethyl malate, diethyl tartrate, dihydrocarveol, dihydromyrcenol, 2,6-dii sopropylphenol, dimethicone copolyol, 2,6-dimethoxyphenol, 1,1-dimethoxy-3,7-dimethyl octan-7-ol, 2,6-dimethyl -4-heptanol, 2,6-dimethylheptan-2-ol, 6,8-dimethyl-2-nonanol, 3,7-dimethyl-2,6-octadien-1-ol, 3,7-dimethyl-1,6-octadi en-3 -ol, 3 ,7-dimethyl-1-octanol, 3,7-dimethyl-3-octanol, 3,7-dimethyl-6-octen-1-ol, 3,7-dimethyl-7-octen-1-ol, dimetol, 2-ethylfenchol, 4-ethylguaiacol, 2-ethyl-1-hexanol, ethyl 2-hydroxybenzoate, ethyl 3 -hydroxybutyrate, 3-ethyl-2-hydroxy-2-cyclopenten-1-one, ethyl-2-hydroxycaproate, ethyl 3 -hydroxyhexanoate, ethyl lactate, ethyl maltol, p-ethylphenol, ethyl salicylate, eugenol, farnesol, fenchyl alcohol, geraniol, glucose pentaacetate, glycerol, glyceryl monostearate, guaiacol, 1-heptanol, 2-heptanol, 3-heptanol, cis-4-heptenol, cis-3-heptenol, n-hexanol, 2-hexanol, 3-hexanol, cis-2-hexenol, cis-3-hexenol, trans-3-hexenol, 4-hexenol, cis-3-hexenylhydrocinnamyl alcohol, 2-hydroxybenzoate, 2-hydroxyacetophenone, 4-hydroxybenzyl alcohol, 3-hydroxy-2-butanone, hydroxycitronellal, 4-(4-hydroxy-3-methoxyphenyl)-2-butanone, 2-hydroxy-3 -methyl-2-cyclopenten-1-one, 4-(p-hydroxyphenyl)-2-butanone, 2-hydroxy-3,5,5-trimethyl-2-cyclohexenone, delta-isoascorbic acid, isoborneol, isoeugenol, isophytol, isopropyl alcohol, p-isopropylbenzyl alcohol, 4-isopropylcyclohexanol, 3-isopropylphenol, 4-isopropylphenol, 2-isopropylphenol, isopulegol, lauryl alcohol, linalool, maltol, menthol, 4-methoxybenzyl alcohol, 2-methoxy-4-methylphenol, 2-methoxy-4-propylphenol, 2-methoxy-4-vinylphenol, a-methylbenzyl alcohol, 2-methylbutanol, 3-methyl-2-butanol, 3-methyl-2-buten-1-ol, 2-methyl-3-buten-2-ol, methyl 2,4-dihydroxy-3,6-dimethylbenzoate, 4-methyl-2, 6-dimethoxyphenol, methyl N-3 ,7-dimethyl -7-hydroxyoctyli deneanthranilate, methyl-3-hydroxyhexanoate, 6-methyl-5-hepten-2-ol, 2-methylpentanol, 3-methyl-3-pentanol, 2-methyl-4-phenylbutan-2-ol, 2-methyl-3-phenylpropan-2-ol, methyl salicylate, 3-methyl-5-(2,2,3 -trimethyl-3 -cyclopenten-1-yl)-4-penten-2-ol, 2-methyl-2-vinyl-5-(1-hydroxy-1-methyl ethyl)-3,4-dihydrofuran, myrtenol, neohesperidin dihydrochalcone, neomenthol, nerol, nerolidol, trans-2-cis-6-nonadienol, 1,3-nonanediol acetate, nonadyl, 2-nonanol, cis-6-nonen-1-ol, trans-2-nonen-1-ol, nonyl alcohol, 1-octanol, 2-octanol, 3 -octanol, ci s-3 -octen-1-ol, ci s-2-octen-1-ol, trans-2-octen-1-ol, ci s-6-octen-1-ol, cis-octen-1-ol, 1-octen-3-ol, oleyl alcohol, patchouli alcohol, 3-pentanol, n-pentanol, 2-pentanol, 1-penten-1-ol, ci s-2-penten-1-ol, perillyl alcohol, 2-phenoxyethanol arabinogalactan, beta-phenethyl alcohol, phenethyl salicylate, phenol, phenylacetaldehyde glyceryl acetal, 3 -phenyl-1-pentanol, 5-phenyl-1-pentanol, 1-phenyl-1-pentanol, 1-phenyl-2-pentanol, 1-phenyl -3-methyl-1-pentanol, phytol, pinacol, polyalkylene glycol, Polysorbate 20, Polysorbate 60, Polysorbate 80, prenol, n-propanol, propenyl guaethol, propylene glycol, 2-propylphenol, 4-propylphenol, resorcinol, retinol, salicylaldehyde, sorbitan monostearate, sorbitol, stearyl alcohol, syringe aldehyde, alpha-terpineol, tetrahydrogeraniol, tetrahydrolinalool, tetrahydromyrcenol, thymol, triethyl citrate, 1,2,6-trihydroxyhexane, p-alpha, alpha-trimethylbenzyl alcohol, 2-0,5, 6-trimethylbicyclo[2 .2.1]hept-2-yl cyclohexanol, 5-(2,2,3 -trimethyl-3 -cyclopentenyl)-3 -methylpentan-2-ol, 3,7,11-trimethyl-2,6,10-dodecatrien-1-ol, 3,7,11-trimethyl-1,6,10-dodecatrien-3 -ol, 3,5,5-trimethyl-1-hexanol, 10-undecen-1-ol, undecyl alcohol, vanillin, o-vanillin, vanillyl butyl ether, 4-vinylphenol, 2,5-xylenol, 2,6-xylenol, 3 ,5-xylenol, 2,4-xylenol, xylose, 5 -(2-methylpropyl)-1-methyl-1-cyclohexene, 1-methylidene-3-(2-methylpropyl)cyclohexane and myrcene.

Very generally, the compound of formula (I) may be used, for example, to release the following fragrance alcohols and phenols: amyl alcohol; hexyl alcohol; 2-hexyl alcohol; heptyl alcohol; octyl alcohol; nonyl alcohol; decyl alcohol; undecyl alcohol; lauryl alcohol; myristin alcohol; 3-methyl-but-2-en-1-ol; 3-methyl-1-pentanol; cis-3 -hexenol; ci s-4-hexenol; 3,5,5 -trimethylhexanol; 3,4,5,6, 6-pentamethylheptan-2-ol; citronellol; geraniol; oct-1-en-3 -ol; 2,5,7-trimethyl-octan-3-ol; 2-cis-3,7-dimethyl-2,6-octadien-1-ol; 6-ethyl-3 -methyl-5 -octen-1-ol; 3 ,7-dimethyl-oct-3 ,6-dienol; 3,7-dimethyloctanol; 7-methoxy-3 , 7-dimethyloctan-2-ol; cis-6-nonenol; 5-ethyl -2-nonanol; 6,8-dimethyl-2-nonanol; 2,2,8-trimethyl-7 (8) -nonen-3-ol; nona-2,6-dien-1-ol; 4-methyl-3-decen-5-ol; dec-9-en-1-ol; benzyl alcohol; 2-methyl-undecanol; 10-undecen-1-ol; 1-phenyl ethanol; 2-phenylethanol; 2-methyl-3 -phenyl-3 -propenol; 2-phenylpropanol; 3 -phenylpropanol; 4-phenyl-2-butanol; 2-methyl-5 -phenylpentanol; 2-methyl-4-phenylpentanol; 3-methyl-5-phenylpentanol; 2-(2-methylphenyl)ethanol; 4-(1-methylethyl)benzene; methanol; 4-(4-hydroxyphenyl)butan-2-one; 2-phenoxyethanol; 4-(1-methylethyl)-2-hydroxy-1-methylbenzene; 2-methoxy-4-methylphenol; 4-methylphenol; anisyl alcohol; p-tolyl alcohol; cinnamic alcohol; vanillin; ethyl vanillin; eugenol; isoeugenol; thymol; anethol; decahydro-2-naphthol; borneol; cedrenol; farnesol; fenchyl alcohol; menthol; 3,7,11-trimethyl-2,6,10-dodecatrien-1-ol; alpha-ionol; tetraionol; 2-(1,1-dimethylethyl)cyclohexanol; 3-(1,1-dimethylethyl)cyclohexanol; 4-(1,1-dimethylethyl)cyclohexanol; 4-isopropylcyclohexanol; 6,6-dimethylbicyclo[3.3.1]hept-2-ene-2-ethanol; 6,6-dimethylbicyclo[3.1.1]hept-2-ene-methanol; p-menth-8-en-3-ol; 3,3,5 -trimethylcyclohexanol; 2,4,6-trimethyl-3-cyclohexenylmethanol; 4-(1-methylethyl)cyclohexanemethanol; 4-(1,1-dimethylethyl)cyclohexanol; 2-(1,1-dimethylethyl)cyclohexanol; 2,2,6-trimethyl-alpha-propylcyclohexanepropanol, 5-(2,2,3-trimethyl-3-cyclo-pentenyl)-3-methylpentan-2-ol; 3-methyl-5-(2,2,3-trimethylcyclopentyl-3-enyl)pent-4-en-2-ol; 2-ethyl-4-(2,2,3-trimethylcyclopentyl-3 -enyl)but-2-en-1 -ol; 4-(5,5,6-trimethylbicyclo[2.2.1]hept-2-yl)cyclohexanol; 2-(2-methylpropyl)-4-hydroxy-4-methyltetrahydropyran; 2-cyclohexylpropanol; 2-(1,1-dimethylethyl)-4-methylcyclohexanol; 1-(2-tert-butyl-cyclohexyloxy)-2-butanol; 1-(4-isopropyl-cyclohexyl)ethanol; 1-(4-hydroxyphenyl)-butan-3-one; 2,6-dimethyloct-7-en-2-ol; 2,6-dimethylheptan-2-ol; 3,7-dimethylocta-1,6-dien-3-ol.

In a further embodiment, the compound is a compound of the following formula (II)

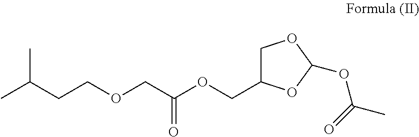 [SMILES: CC(=O)OC1OCC(COC(=O)COCCC(C)C)O1]

The microcapsules may be stably incorporated into typical washing or cleaning agents, cosmetics or other odorant-containing compositions. They allow an immediate but also delayed release of the stored fragrance alcohols and fragrance alkenes. A non-limiting fragrance is allyl isoamyl glycolate. These fragrances impart a particularly long-lasting impression of freshness to typical washing or cleaning agents and cosmetics. In particular the dried, washed textile benefits from the good fragrance effect of long-term freshness. The stored odorant is released slowly by means of the action of Bronsted and/or Lewis acids. The action of Bronsted acids is advantageous.

Another non-limiting aspect relates to a washing or cleaning agent, containing microcapsules as described herein.

It is in this respect possible for the washing or cleaning agent, or other agents that comprise the microcapsules, to comprise different microcapsules. This means that the capsules have, for example, a different wall thickness such that the capsules burst, and the stored fragrance is thus released, at different pressures. This allows a release of the stored fragrance over a longer period of time and thus a long-lasting experience of fragrance.

A further non-limiting embodiment includes a cosmetic agent that comprises the microcapsules.

Another non-limiting embodiment includes an air-care agent that contains the microcapsules described herein.

Lastly, another non-limiting embodiment includes a method for long-lastingly fragrancing surfaces.

One non-limiting embodiment includes a washing or cleaning agent, such as a washing agent, softener or auxiliary washing agent, containing at least one microcapsule. In various embodiments, microcapsules are contained in amounts of between 0.01 and 10 wt. %, advantageously between 0.05 and 8 wt. %, more advantageously between 0.05 and 5 wt. %, in particular between 0.1 and 3 wt. %, in each case based on the overall agent. Suitable cleaning agents are e.g. cleaning agents for hard surfaces, such as dishwasher detergents. The cleaning agents may also be cleaning agents such as household cleaners, all-purpose cleaners, window cleaners, floor cleaners, etc. The cleaning agent may be a product for cleaning toilet bowls and urinals, advantageously a flush cleaner for being hung in the toilet bowl.

According to a non-limiting embodiment, the washing or cleaning agent contains at least one surfactant selected from anionic, cationic, nonionic, zwitterionic and amphoteric surfactants or mixtures thereof.

According to a further non-limiting embodiment, the agent is present in solid or liquid form.

A further non-limiting embodiment includes a cosmetic agent, containing microcapsules, that contains the microcapsules in amounts of between 0.01 and 10 wt. %, advantageously between 0.05 and 8 wt. %, more advantageously between 0.05 and 5 wt. %, in particular between 0.1 and 3 wt. %, in each case based on the overall agent.

A further i non-limiting embodiment includes an air-care agent (e.g. room air freshener, room deodorizer, room spray, etc.) containing microcapsules, wherein the microcapsules being contained in amounts of between 0.01 and 10 wt. %, advantageously between 0.05 and 8 wt. %, more advantageously between 0.05 and 5 wt. %, in particular between 0.1 and 3 wt. %, in each case based on the total weight of the agent.

According to a further non-limiting embodiment, additional fragrances are contained in an agent, i.e. a washing or cleaning agent, cosmetic agent or air-care agent, said additional fragrances being in particular selected from the group comprising fragrances of natural or synthetic origin, such as more volatile fragrances, higher-boiling fragrances, solid fragrances and/or adherent fragrances.

Examples of adherent odorants that are advantageously usable are essential oils such as angelica root oil, anise oil, arnica blossom oil, basil oil, bay oil, bergamot oil, champaca blossom oil, noble fir oil, noble fir cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, cajuput oil, calamus oil, chamomile oil, camphor oil, cananga oil, cardamom oil, cassia oil, pine needle oil, copaiba balsam oil, coriander oil, spearmint oil, caraway oil, cumin oil, lavender oil, lemongrass oil, lime oil, mandarin oil, melissa oil, musk seed oil, myrrh oil, clove oil, neroli oil, niaouli oil, olibanum oil, orange oil, oregano oil, palmarosa oil, patchouli oil, Peru balsam oil, petitgrain oil, pepper oil, peppermint oil, allspice oil, pine oil, rose oil, rosemary oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil.

However, higher-boiling and solid odorants of natural or synthetic origin may also be used as adherent odorants or odorant mixtures, i.e. fragrances. These compounds include the compounds indicated in the following and mixtures thereof: ambrettolide, alpha-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmone, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl beta-naphthyl ketone, methyl n-nonyl acetaldehyde, methyl n-nonyl ketone, muscone, beta-naphthol ethyl ether, beta-naphthol methyl ether, nerol, nitrobenzene, n-nonyl aldehyde, nonyl alcohol, n-octylaldehyde, p-oxyacetophenone, pentadecanolide, beta-phenethyl alcohol, phenylacetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, gamma-undecalactone, vanillin, veratraldehyde, cinnamaldehyde, cinnamyl alcohol, cinnamic acid, cinnamic acid ethyl ester, cinnamic acid benzyl ester. The more volatile fragrances include in particular lower-boiling odorants of natural or synthetic origin, which may be used alone or in mixtures. Examples of more volatile fragrances are alkyl isothiocyanates (alkyl mustard oils), butanedione, limonene, linalool, linayl acetate and propionate, menthol, menthone, methyl-n-heptenone, phellandrene, phenylacetaldehyde, terpinyl acetate, citral and citronellal.

According to a further non-limiting embodiment, the agent (i.e. a washing or cleaning agent, cosmetic agent or air-care agent) comprises at least one, or a plurality of, active components, in particular washing, care, cleansing and/or cosmetic components, advantageously selected from the group comprising anionic surfactants, cationic surfactants, amphoteric surfactants, nonionic surfactants, acidifying agents, alkalizing agents, anti-crease compounds, antibacterial substances, antioxidants, anti-redeposition agents, antistatic agents, builders, bleaching agents, bleach activators, bleach stabilizers, bleach catalysts, ironing aids, cobuilders, fragrances, shrinkage preventers, electrolytes, enzymes, color protectants, colorants, dyes, dye transfer inhibitors, fluorescing agents, fungicides, germicides, odor-complexing substances, adjuvants, hydrotropes, rinse aids, complexing agents, preservatives, corrosion inhibitors, water-miscible organic solvents, optical brighteners, perfumes, perfume carriers, luster agents, pH adjusters, proofing and impregnation agents, polymers, anti-swelling and anti-slip agents, foam inhibitors, phyllosilicates, soil-repellent substances, silver protectants, silicone oils, soil-release active ingredients, UV protection substances, viscosity regulators, thickeners, discoloration inhibitors, graying inhibitors, vitamins and/or softeners. As used herein, unless indicated otherwise, stated amounts in wt. % refer to the total weight of the agent.

The amounts of the individual ingredients in the agents (i.e. a washing or cleaning agent, cosmetic agent or air-care agent) depend on the intended purpose of the agents in question, and a person skilled in the art is in principle familiar with the ranges of the amounts of ingredients that should be used, or may obtain these from the relevant technical literature. Depending on the intended purpose of the agents, the surfactant content, for example, is selected to be higher or lower. The surfactant content of washing agents may typically be e.g. between 10 and 50 wt. %, alternatively between 12.5 and 30 wt. %, and in particular between 15 and 25 wt. %, while, for example, cleaning agents for automatic dishwashing may contain e.g. between 0.1 and 10 wt. %, alternatively between 0.5 and 7.5 wt. %, and in particular between 1 and 5 wt. % surfactants.

The agents (i.e. a washing or cleaning agent, cosmetic agent or air-care agent) may contain surfactants, such as anionic surfactants, nonionic surfactants and mixtures thereof, but also cationic surfactants. Suitable nonionic surfactants are in particular ethoxylation and/or propoxylation products of alkyl glycosides and/or linear or branched alcohols each having 12 to 18 carbon atoms in the alkyl portion and 3 to 20, alternatively 4 to 10, alkyl ether groups. Also usable are corresponding ethoxylation and/or propoxylation products of N-alkylamines, vicinal diols, fatty acid esters and fatty acid amides which, with regard to the alkyl portion, correspond to the stated long-chain alcohol derivatives, and of alkylphenols having 5 to 12 carbon atoms in the alkyl group.

Suitable anionic surfactants are in particular soaps and those containing sulfate or sulfonate groups having alkali ions as cations. Usable soaps are alkali salts of saturated or unsaturated fatty acids having 12 to 18 carbon atoms. Fatty acids of this kind may also be used in a not completely neutralized form. Usable sulfate-type surfactants include salts of sulfuric acid semiesters of fatty alcohols having 12 to 18 carbon atoms and the sulfation products of the stated nonionic surfactants having a low degree of ethoxylation. Usable sulfonate-type surfactants include linear alkylbenzenesulfonates having 9 to 14 carbon atoms in the alkyl portion, alkanesulfonates having 12 to 18 carbon atoms, and olefin sulfonates having 12 to 18 carbon atoms, resulting from the reaction of corresponding monoolefins with sulfur trioxide, and alpha-sulfo fatty acid esters, resulting from the sulfonation of fatty acid methyl or ethyl esters.

Cationic surfactants are selected from among esterquats and/or quaternary ammonium compounds (QAC) of general formula (R^{I})(R^{II})(R^{III})(R^{IV})N⁺X⁻, in which R^{I} to R^{IV} represent C₁₋₂₂ alkyl groups, C₇₋₂₈ arylalkyl groups or heterocyclic groups that are the same or different, where two groups or, in the case of aromatic bonding such as in pyridine, even three groups form, together with the nitrogen atom, the heterocycle, e.g. a pyridinium or imidazolinium compound, and X⁻ represents halide ions, sulfate ions, hydroxide ions or similar anions. QACs may be produced by reacting tertiary amines with alkalizing agents, e.g. methyl chloride, benzyl chloride, dimethyl sulfate, dodecyl bromide, but also ethylene oxide. The alkylation of tertiary amines with a long alkyl group and two methyl groups is particularly simple; the quaternization of tertiary amines with two long groups and a methyl group may also be carried out under mild conditions using methyl chloride. Amines having three long alkyl groups or hydroxy-substituted alkyl functional groups are less reactive, and are quaternized e.g. using dimethyl sulfate. Examples of suitable QACs are benzalkonium chloride (N-alkyl-N,N-dimethylbenzyl ammonium chloride), B enzalkon B (m,p-dichlorobenzyl dimethyl-C₁₂-alkylammonium chloride, benzoxonium chloride (benzyldodecyl-bis-(2-hydroxyethyl) ammonium chloride), cetrimonium bromide (N-hexadecyl-N,N-trimethylammonium bromide), benzethonium chloride (N,N-dimethyl-N-[2-[2-[p-(1,1,3,3 -tetramethylbutyl)phenoxy]ethoxy]ethyl]benzylammonium chloride), dialkyldimethyl ammonium chlorides such as di-n-decyldimethyl ammonium chloride, didecyldimethyl ammonium bromide, dioctyldimethyl ammonium chloride, 1-cetylpyridinium chloride and thiazoline iodide, and mixtures thereof. QACs are benzalkonium chlorides having C₈-C₂₂ alkyl groups, in particular C₁₂-C₁₄ alkylbenzyldimethyl ammonium chloride.

Non-limiting esterquats are methyl-N-(2-hydroxyethyl)-N,N-di(talgacyl oxyethyl) ammonium methosulfate, bis-(palmitoyl)ethylhydroxyethylmethyl ammonium methosulfate or methyl-N,N-bis(acyloxyethyl)-N-(2-hydroxyethyl) ammonium methosulfate. Commercially available examples are the methylhydroxyalkyldialkoyloxyalkyl ammonium methosulfates marketed by Stepan under the trademark Stepantex®, the products from BASF SE known under the trade name Dehyquart, or the products from the manufacturer Evonik known under the name Rewoquat.

Surfactants are contained in the agents (i.e. a washing or cleaning agent, cosmetic agent or air-care agent) in amount proportions of from 5 wt. % to 50 wt. %, in particular from 8 wt. % to 30 wt. %, alternatively up to 30 wt. %, in particular from 5 wt. % to 15 wt. %, surfactants, such as including cationic surfactants at least in part, are used in particular in laundry aftertreatment agents.

An agent, in particular a washing or cleaning agent, contains at least one water-soluble and/or water-insoluble, organic and/or inorganic builder. The water-soluble organic builders include polycarboxylic acids, in particular citric acid and sugar acids, monomeric and polymeric aminopolycarboxylic acids, in particular methylglycinediacetic acid, nitrilotriacetic acid and ethylenediaminetetraacetic acid, and polyaspartic acid, polyphosphonic acids, in particular amino tris(methylenephosphonic acid), ethylenediamine tetrakis(methylenephosphonic acid) and 1-hydroxyethane-1,1-diphosphonic acid, polymeric hydroxy compounds such as dextrin, and polymeric (poly)carboxylic acids, polymeric acrylic acids, methacrylic acids, maleic acids and mixed polymers thereof, which may also contain, in the polymer, small proportions of polymerizable substances without a carboxylic acid functionality. Compounds of this class which are suitable, are copolymers of acrylic acid or methacrylic acid with vinyl ethers, such as vinyl methyl ethers, vinyl ester, ethylene, propylene and styrene, in which the proportion of the acid is at least 50 wt. %. The organic builders may, in particular for the production of liquid agents, be used in the form of aqueous solutions, e.g. in the form of 30 to 50 wt. % aqueous solutions. All indicated acids are generally used in the form of water-soluble salts thereof, in particular alkali salts thereof.

Organic builders may, if desired, be contained in amounts of up to 40 wt. %, in particular up to 25 wt. %, and alternatively from 1 wt. % to 8 wt. %. Amounts close to the stated upper limit are used in paste-form or liquid, in particular water-containing, agents. Laundry aftertreatment agents, such as softeners, may optionally also be free of organic builder.

In particular alkali silicates and polyphosphates, e.g. sodium triphosphate, are suitable as water-soluble inorganic builder materials. In particular crystalline or amorphous alkali aluminosilicates may, if desired, be used in amounts of up to 50 wt. %, alternatively no more than 40 wt. %, and, in liquid agents, in particular from 1 wt. % to 5 wt. %, as water-insoluble, water-dispersible inorganic builder materials. Among these, crystalline sodium aluminosilicates of washing agent quality, in particular zeolite A, P and optionally X, are used. Amounts close to the stated upper limit are used in solid particulate agents. Suitable aluminosilicates have in particular no particles having a particle size greater than 30 μm and alternatively comprise at least 80 wt. % particles having a size smaller than 10 μm.

Suitable substitutes or partial substitutes for the stated aluminosilicate are crystalline alkali silicates, which may be present alone or in a mixture with amorphous silicates. The alkali silicates that are usable in the agents as builders have a molar ratio of alkali oxide to SiO₂ of less than 0.95, in particular from 1:1.1 to 1:12, and may be present in amorphous or crystalline form. Non-limiting alkali silicates are sodium silicates, in particular amorphous sodium silicates, having a Na₂O: SiO₂ molar ratio of from 1:2 to 1:2.8. Non-limiting examples of crystalline silicates, which may be present alone or in a mixture with amorphous silicates, are crystalline phyllosilicates of general formula Na₂SiₓO₂ₓ₊₁.y H₂O, where x, referred to as the module, is a number from 1.9 to 4, y is a number from 0 to 20, and non-limiting values for x are 2, 3 or 4. Non-limiting crystalline phyllosilicates are those in which x in the stated general formula attains the values 2 or 3. In particular, both beta-sodium and delta-sodium disilicates (Na₂Si₂O₅.y H₂O) are used. Practically water-free crystalline alkali silicates of the above general formula, in which x is a number from 1.9 to 2.1 and which are produced from amorphous alkali silicates, may also be used in agents. In a further non-limiting embodiment of agents, a crystalline sodium phyllosilicate having a module of 2 to 3, as can be produced from sand and soda, is used. Crystalline sodium silicates having a module in the range of from 1.9 to 3.5 are used in a further non-limiting embodiment of agents. If alkali aluminosilicate, in particular zeolite, is also present as an additional builder, the weight ratio of aluminosilicate to silicate, in each case based on water-free active substances, is from 1:10 to 10:1. In agents containing both amorphous and crystalline alkali silicates, the weight ratio of amorphous alkali silicate to crystalline alkali silicate is from 1:2 to 2:1 and alternatively from 1:1 to 2:1.

Builders are, if desired, contained in the agents in amounts of up to 60 wt. %, in particular from 5 wt. % to 40 wt. %. Laundry aftertreatment agents, e.g. softeners, are free of inorganic builder.

In particular organic peracids or peracid salts of organic acids, such as phthalimidopercapronic acid, perbenzoic acid or salts of diperdodecanedioic acid, hydrogen peroxide and inorganic salts that release hydrogen peroxide under the application conditions, such as perborate, percarbonate and/or persilicate, are suitable as peroxygen compounds. If solid peroxygen compounds are intended to be used, these may be used in the form of powders or granules, which may also be coated in a manner known in principle. The optional use of alkali percarbonate, alkali perborate monohydrate or, in particular in liquid agents, hydrogen peroxide in the form of aqueous solutions containing from 3 wt. % to 10 wt. % hydrogen peroxide, is used. If an agent contains bleaching agents, such as peroxygen compounds, these are present in amounts of up to 50 wt. %, in particular from 5 wt. % to 30 wt. %. The addition of small amounts of known bleaching agent stabilizers such as phosphonates, borates or metaborates, metasilicates, and magnesium salts such as magnesium sulfate may be expedient.

Compounds which, under perhydrolysis conditions, result in aliphatic peroxocarboxylic acids having 1 to 10 carbon atoms, in particular 2 to 4 carbon atoms, and/or optionally substituted perbenzoic acid, may be used as bleach activators. Substances that have O-acyl and/or N-acyl groups of the stated number of C atoms and/or optionally substituted benzoyl groups are suitable. Non-limiting examples are polyacylated alkylene diamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoyl succinimide (NOSI), acylated phenolsulfonates, in particular n-nonanoyl- or isononanoyloxybenzenesulfonate (n- or iso-NOBS), carboxylic acid anhydrides, in particular phthalic acid anhydride, acylated polyhydric alcohols, in particular triacetin, ethylene glycol diacetate, 2,5-diacetoxy-2,5-dihydrofuran and enol ester, and acetylated sorbitol and mannitol or mixtures thereof (SORMAN), acylated sugar derivatives, in particular pentaacetyl glucose (PAG), pentaacetyl fructose, tetraacetyl xylose and octaacetyl lactose, and acetylated, optionally N-alkylated glucamine and gluconolactone, and/or N-acylated lactams, for example N-benzoylcaprolactam. Hydrophilically substituted acyl acetals and acyl lactams are likewise used. Combinations of conventional bleach activators may also be used. Bleach activators of this kind may be contained in a typical amount range, such as in amounts of from 1 wt. % to 10 wt. %, in particular from 2 wt. % to 8 wt. %, based on the overall agent.

In addition to or instead of the conventional bleach activators listed above, sulfonimines and/or bleach-enhancing transition metal salts or transition metal complexes may also be contained as what are referred to as bleach catalysts.

Suitable as enzymes that can be used in the agents are those from the class of proteases, cutinases, amylases, pullulanases, hemicellulases, cellulases, lipases, oxidases and peroxidases, and mixtures thereof. Enzymatic active ingredients obtained from fungi or bacteria, such as Bacillus subtilis, Bacillus licheniformis, Streptomyces griseus, Humicola lanuginosa, Humicola insolens, Pseudomonas pseudoalcaligenes or Pseudomonas cepacia are particularly suitable. The optionally used enzymes may be adsorbed on carrier substances and/or embedded in coating substances to protect said enzymes from premature inactivation. The enzymes are, if desired, contained in the agents in amounts no greater than 5 wt. %, in particular from 0.2 wt. % to 2 wt. %.

The agents may optionally contain, for example, derivatives of diaminostilbene disulfonic acid or alkali metal salts thereof as optical brighteners. Suitable are, for example, salts of 4,4′-bis(2-anilino-4-morpholino-1,3,5-triazinyl-6-amino)stilbene-2,2′-disulfonic acid or compounds having a similar structure which, instead of the morpholino group, have a diethanolamino group, a methylamino group, an anilino group or a 2-methoxyethylamino group.

Suitable foam inhibitors include, for example, organopolysiloxanes and mixtures thereof with microfine, optionally silanated silicic acid and paraffin waxes and mixtures thereof with silanated silicic acid or bis-fatty acid alkylene diamides. Mixtures of various foam inhibitors are also advantageously used, for example those made up of silicones, paraffins or waxes. The foam inhibitors, in particular silicone-containing and/or paraffin-containing foam inhibitors, are bound to a granular carrier substance that is soluble or dispersible in water. Mixtures of paraffin waxes and bistearylethylenediamides are used.

In addition, the agents may also contain components that positively influence the capability for washing out oil and grease from textiles, or what are referred to as soil-release active ingredients. This effect is particularly apparent when a textile is soiled which has been previously washed several times using an agent that contains this deoiling and degreasing component. Non-limiting examples of deoiling and degreasing components include, for example, nonionic cellulose ethers such as methylcellulose and methylhydroxypropylcellulose having a proportion of from 15 to 30 wt. % methoxyl groups and from 1 to 15 wt. % hydroxypropoxyl groups, in each case based on the nonionic cellulose ether, and the polymers of phthalic acid and/or terephthalic acid known from the prior art, or derivatives thereof, with monomeric and/or polymeric diols, in particular polymers of ethylene terephthalates and/or polyethylene glycol terephthalates or anionically and/or nonionically modified derivatives thereof

The agents may also contain dye transfer inhibitors, in amounts of from 0.1 wt. % to 2 wt. %, alternatively from 0.1 wt. % to 1 wt. %, which, in a non-limiting embodiment, are polymers of vinylpyrrolidone, vinyl imidazole or vinyl pyridine-N-oxide, or copolymers thereof

The function of graying inhibitors is to keep the dirt that is removed from the textile fiber suspended in the liquor. Water-soluble colloids, which are usually organic, are suitable for this purpose, for example starch, sizing material, gelatine, salts of ethercarboxylic acids or ethersulfonic acids of starch or of cellulose, or salts of acidic sulfuric acid esters of cellulose or of starch. Water-soluble polyamides containing acidic groups are also suitable for this purpose. Starch derivatives other than those mentioned above may also be used, for example aldehyde starches. Cellulose ethers, such as carboxymethylcellulose (Na salt), methylcellulose, hydroxyalkylcellulose, and mixed ethers, such as methylhydroxyethylcellulose, methylhydroxypropylcellulose, methylcarboxymethylcellulose and mixtures thereof, may be used, for example, in amounts of from 0.1 to 5 wt. %, based on the agents.

The organic solvents that are usable in the agents, in particular when the agents are present in liquid or paste-like form, include alcohols having 1 to 4 carbon atoms, in particular methanol, ethanol, isopropanol and tert-butanol, diols having 2 to 4 carbon atoms, in particular ethylene glycol and propylene glycol, and mixtures thereof, and the ethers that are derivable from the mentioned compound classes. Water-miscible solvents of this kind are present in the agents in amounts no greater than 30 wt. %, in particular from 6 wt. % to 20 wt. %.

For setting a desired pH that does not result from mixing the other components themselves, the agents may contain acids that are compatible with the system and the environment, in particular citric acid, acetic acid, tartaric acid, malic acid, lactic acid, glycolic acid, succinic acid, glutaric acid and/or adipic acid, but also mineral acids, in particular sulfuric acid, or bases, in particular ammonium or alkali hydroxides. pH regulators of this kind are optionally contained in the agents in amounts no greater than 20 wt. %, in particular from 1.2 wt. % to 17 wt. %.

The production of solid agents (i.e. in particular washing or cleaning agents) poses no difficulties, and may take place in a manner known in principle, for example by spray drying or granulation, with an optional peroxygen compound and an optional bleach catalyst being optionally added later. For the production of agents having an increased bulk weight, in particular in the range of from 650 g/l to 950 g/l, a method having an extrusion step is used. The production of liquid agents does not pose any difficulties either, and may likewise take place in a known manner.

According to a non-limiting embodiment, the teaching may be used to significantly reduce the perfume proportion in washing, cleaning and body care agents. It is thus possible to also provide perfumed products for particularly sensitive consumers who, due to specific intolerances and irritations, can use the normally perfumed products only on a limited basis or not at all.

In various embodiments, the washing or cleaning agents are present in liquid or in solid form.

A solid, in particular powdered, washing agent, in addition to the compound, may also contain in particular components that are e.g. selected from the following:
anionic surfactants, such as alkylbenzenesulfonate, alkyl sulfate, e.g. in amounts of from 5 to 30 wt. %,
nonionic surfactants, such as fatty alcohol polyglycol ethers, alkyl polyglucoside, fatty acid glucamide, e.g. in amounts of from 0.5 to 15 wt. %,
builders, e.g. zeolite, polycarboxylate, sodium citrate, in amounts of e.g. from 0 to 70 wt. %, advantageously from 5 to 60 wt. %, alternatively from 10 to 55 wt. %, in particular from 15 to 40 wt. %,
alkalis, e.g. sodium carbonate, in amounts of e.g. from 0 to 35 wt. %, advantageously from 1 to 30 wt. %, alternatively from 2 to 25 wt. %, in particular from 5 to 20 wt. %,
bleaching agents, e.g. sodium perborate, sodium percarbonate, in amounts of e.g. from 0 to 30 wt. %, advantageously from 5 to 25 wt. %, alternatively from 10 to 20 wt. %,
corrosion inhibitors, e.g. sodium silicate, in amounts of e.g. from 0 to 10 wt. %, advantageously from 1 to 6 wt. %, alternatively from 2 to 5 wt. %, in particular from 3 to 4 wt. %,
stabilizers, e.g. phosphonates, advantageously from 0 to 1 wt. %,
foam inhibitors, e.g. soap, silicone oils, paraffins, advantageously from 0 to 4 wt. %, alternatively from 0.1 to 3 wt. %, in particular from 0.2 to 1 wt. %,
enzymes, e.g. proteases, amylases, cellulases, lipases, advantageously from 0 to 2 wt. %, alternatively from 0.2 to 1 wt. %, in particular from 0.3 to 0.8 wt. %,
graying inhibitors, e.g. carboxymethylcellulose, advantageously from 0 to 1 wt. %,
discoloration inhibitors, e.g. polyvinylpyrrolidone derivatives, alternatively from 0 to 2 wt. %,
adjusters, e.g. sodium sulfate, advantageously from 0 to 20 wt. %,
optical brighteners, e.g. stilbene derivatives, biphenyl derivatives, advantageously from 0 to 0.4 wt. %, in particular from 0.1 to 0.3 wt. %,
optionally further fragrances,
optionally water,
optionally soap,
optionally bleach activators,
optionally cellulose derivatives,
optionally soil-repellent agents,
   in wt. %, in each case based on the overall agent.

In another embodiment, the agent is present in liquid form, e.g. in gel form. Non-limiting examples of liquid washing or cleaning agents and cosmetics have water contents of e.g. from 10 to 95 wt. %, alternatively from 20 to 80 wt. %, and in particular from 30 to 70 wt. %, based on the overall agent. In the case of liquid concentrates, the water content may also be particularly low, e.g. <30 wt. %, alternatively <20 wt. %, in particular <15 wt. %, in wt. % in each case based on the overall agent. The liquid agents may also contain nonaqueous solvents.

A liquid, in particular gel-form, washing agent, in addition to the compound, may also contain in particular components that are e.g. selected from the following:
anionic surfactants, such as alkylbenzenesulfonate, alkyl sulfate, e.g. in amounts of from 5 to 40 wt. %,
nonionic surfactants, such as fatty alcohol polyglycol ethers, alkyl polyglucoside, fatty acid glucamide, e.g. in amounts of from 0.5 to 25 wt. %,
builders, e.g. zeolite, polycarboxylate, sodium citrate, advantageously from 0 to 15 wt. %, alternatively from 0.01 to 10 wt. %, in particular from 0.1 to 5 wt. %,
foam inhibitors, e.g. soap, silicone oils, paraffins, in amounts of e.g. from 0 to 10 wt. %, advantageously from 0.1 to 4 wt. %, alternatively from 0.2 to 2 wt. %, in particular from 1 to 3 wt. %,
enzymes, e.g. proteases, amylases, cellulases, lipases, in amounts of e.g. from 0 to 3 wt. %, advantageously from 0.1 to 2 wt. %, alternatively from 0.2 to 1 wt. %, in particular from 0.3 to 0.8 wt. %,
optical brighteners, e.g. stilbene derivatives, biphenyl derivatives, in amounts of e.g. from 0 to 1 wt. %, advantageously from 0.1 to 0.3 wt. %, in particular from 0.1 to 0.4 wt. %,
optionally further fragrances,
optionally stabilizers,
water,
optionally soap, in amounts of e.g. from 0 to 25 wt. %, advantageously from 1 to 20 wt. %, alternatively from 2 to 15 wt. %, in particular from 5 to 10 wt. %,
optionally solvents (e.g. alcohols), advantageously from 0 to 25 wt. %, alternatively from 1 to 20 wt. %, in particular from 2 to 15 wt. %,
   in wt. %, in each case based on the overall agent.

A non-limiting liquid softener, in addition to the ketone, may also contain in particular components that are selected from the following:
cationic surfactants, such as in particular esterquats, e.g. in amounts of from 5 to 30 wt. %,
cosurfactants, e.g. glycerol monostearate, stearic acid, fatty alcohols, fatty alcohol ethoxylates, e.g. in amounts of from 0 to 5 wt. %, alternatively from 0.1 to 4 wt. %,
emulsifiers, e.g. fatty amine ethoxylates, e.g. in amounts of 0 to 4 wt. %, alternatively from 0.1 to 3 wt. %,
optionally further fragrances,
dyes, in the ppm range,
stabilizers, in the ppm range,
solvents, e.g. water, in amounts of from 60 to 90 wt. %, in wt. %, in each case based on the overall agent.

Another non-limiting embodiment includes a method for fragrancing surfaces, wherein a compound of formula (I) or a washing or cleaning agent, cosmetic agent or air-care agent is applied to the surface to be fragranced (e.g. textiles, dishes, floors), and the compound or the agent is then (i) heated to a temperature of from 20° C. to 250° C., alternatively from 20° C. to 90° C., and/or (ii) brought into contact with a Lewis acid and/or Bronsted acid, alternatively with a Bronsted acid.

The acidic protective mantle (hydrolipid mantle) of the skin is suitable for the acid-induced release of the stored fragrances, which protective mantle is formed mainly by secretions from the skin, such as sweat and fatty acids, and sets a pH of approximately 4 to 7 on the skin. Said protective mantle causes the fragrances to be released in a delayed manner as described herein, for example if the compound of formula (I) is applied to a textile that is brought into contact with said protective mantle.

All embodiments that have been described herein in connection with the compounds of formula (I) can similarly also be applied to the described agents, methods and uses, and vice versa. Further embodiments can be found in the following examples; however, the invention is not limited to these examples.

### PRACTICAL EXAMPLES

In the following examples, the splitting of orthoformic acid esters which were contained in the shell of a microcapsule was examined. During the splitting, the following reaction takes place:

### Splitting Reaction of Orthoformic Acid Esters

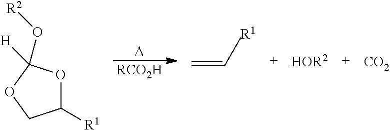

A fragrance and CO₂ are thus released.

Use of Perfume Capsules in Softeners

Conventional perfume capsules were incorporated into one of three commercially available, unperfumed softeners, and perfume microcapsules, containing an orthoformic acid ester of allyl amyl glycolate, were incorporated into the other two softeners.

In a Softronic W 1734 washing machine from Miele, cotton towel-drying articles having a size of 30×30 cm and a total weight of 3.5 kg were washed in a washing cycle at a temperature of 20° C. The spin speed was 1,200 rpm; water having a water hardness of 12° dH was used. After the wash, drying took place at 20° C. and 50-60% relative air humidity.

In each washing cycle, one of the three softeners according to the table was added. In the following example 1, a softener having conventional perfume microcapsules was used as a comparative example. In each of examples 2 and 3, the softener received microcapsules. In all the examples, 35 ml of softener was metered.

Subsequently, an olfactory assessment was carried out by a panel of persons trained in odors. The following values are average values from six assessments (n=6).

| | | | | | Olfactory assessment | | | |
|---|---|---|---|---|---|---|---|---|
| | | | | | Dry | Fragrance | Damp | |
| | Amount | Perfume | | | laundry | boost | laundry | Product |
| No. | (wt. %) | capsules used | Softener | Criterion | Intensity | Intensity | Intensity | Intensity |
| 1 | 0.20 | Standard | Vernel | Normal | 1.00 | 3.50 | 3.00 | 2.00 |
| | | capsules having | Base | After | 1.00 | 3.50 | | |
| | | perfume A | | drying | | | | |
| | | | | After | 1.00 | 3.50 | | |
| | | | | ironing | | | | |
| 2 | 0.20 | Thermocapsules | Vernel | Normal | 1.00 | 2.00 | 4.00 | 5.00 |
| | | having perfume | Base | After | 1.00 | 4.00 | | |
| | | A together with | | drying | | | | |
| | | 20 wt. % | | After | 2.00 | 4.00 | | |
| | | orthoformic | | ironing | | | | |
| | | acid ester | | | | | | |
| 3 | 0.20 | Thermocapsules | Vernel | Normal | 1.00 | 3.50 | 3.00 | 4.00 |
| | | having perfume | Base | After | 1.00 | 4.00 | | |
| | | A together with | | drying | | | | |
| | | 25 wt. % | | After | 2.00 | 4.00 | | |
| | | orthoformic | | ironing | | | | |
| | | acid ester | | | | | | |

By means of the microcapsules (examples 2 and 3), an increased odor intensity (fragrance boost) was observed in particular after drying and after ironing, i.e. after thermal treatment.

What is claimed is:

1. Microcapsules, comprising a core and a shell, wherein the core comprises a compound of general formula (I) 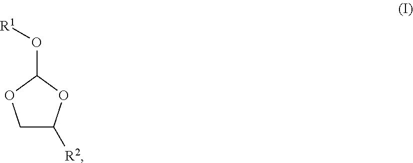
wherein
R¹ and R² are each selected, independently of one another, from a linear, aliphatic, olefinic or open-chain organic group having from 2 to 20 carbon atoms and having from 0 to 10 heteroatoms selected from N, O, S, and Si; a branched or cyclic organic group having from 3 to 20 carbon atoms and having from 0 to 10 heteroatoms selected from N, O, S, and Si; an aromatic or heteroaromatic organic group having from 4 to 20 carbon atoms and having from 0 to 10 heteroatoms selected from N, O, S, and Si.

2. The microcapsules according to claim 1, wherein the shell comprises a wall material selected from the group consisting of melamine-/urea-/formaldehyde-, melamine-/formaldehyde-, urea-/formaldehyde-, polyacrylate copolymer, or combinations thereof.

3. The microcapsules according to claim 1, wherein the microcapsules have a surface coating with a cationic polymer over part of or the whole surface.

4. The microcapsules according to claim 1, wherein the core has the compound of general formula (I) in a proportion of from about 0.001 to about 50 wt. % based on the total weight of the core.

5. The microcapsules according to claim 1, wherein R¹ and R² are selected, independently of one another, from the group consisting of substituted or unsubstituted, linear or branched alkyl, alkenyl or alkynyl having up to 20 carbon atoms, substituted or unsubstituted, linear or branched heteroalkyl, heteroalkenyl or heteroalkynyl having up to 20 carbon atoms, and having from 1 to 6 heteroatoms selected from O, S_{z} and N, substituted or unsubstituted aryl having up to 20 carbon atoms, substituted or unsubstituted heteroaryl having up to 20 carbon atoms, and having from 1 to 6 heteroatoms selected from O, S and N, cycloalkyl or cycloalkenyl having up to 20 carbon atoms, and heterocycloalkyl or heterocycloalkenyl having up to 20 carbon atoms, and having from 1 to 6 heteroatoms selected from O, S, and N.

6. The microcapsules according to claim 1, wherein in the formula (I), R¹ or R² is a group derived from a fragrance alkene or a fragrance alcohol.

7. The compound according to claim 6, wherein the fragrance alkene or the fragrance alcohol is selected from the group consisting of acetovanillone, allyl amyl glycolate, allyl isoamyl glycolate, alpha-amyl cinammyl alcohol, anisyl alcohol, benzoin, benzyl alcohol, benzyl salicylate, 1-butanol, butyl lactate, 2-t-butyl-5-methylphenol, 2-t-butyl-6-methylphenol, carvacrol, carveol, 4-carvomenthenol, cedrol, cetyl alcohol, cinnamic alcohol, citronellol, o-cresol, m-cresol, p-cresol, crotyl alcohol, decahydro-2-naphthol, 1-decanol, 1-decen-3-ol, 9-decen-1-ol, diethyl malate, diethyl tartrate, dihydrocarveol, dihydromyrcenol, 2,6-diisopropylphenol, dimethicone copolyol, 2,6-dimethoxyphenol, 1,1-dimethoxy-3,7-dimethyloctan-7-ol, 2,6-dimethyl-4-heptanol, 2,6-dimethylheptan-2-ol, 6,8-dimethyl-2-nonanol, 3,7-dimethyl-2,6-octadien-1-ol, 3,7-dimethyl-1,6-octadien-3 -ol, 3,7-dimethyl-1-octanol, 3,7-dimethyl-3-octanol, 3,7-dimethyl-6-octen-1-ol, 3,7-dimethyl-7-octen-1-ol, dimetol, 2-ethylfenchol, 4-ethylguaiacol, 2-ethyl-1-hexanol, ethyl 2-hydroxybenzoate, ethyl 3-hydroxybutyrate, 3-ethyl-2-hydroxy-2-cyclopenten-1-one, ethyl-2-hydroxycaproate, ethyl 3-hydroxyhexanoate, ethyl lactate, ethyl maltol, p-ethylphenol, ethyl salicylate, eugenol, farnesol, fenchyl alcohol, geraniol, glucose pentaacetate, glycerol, glyceryl monostearate, guaiacol, 1-heptanol, 2-heptanol, 3-heptanol, cis-4-heptenol, cis-3-heptenol, n-hexanol, 2-hexanol, 3-hexanol, cis-2-hexenol, cis-3-hexenol, trans-3-hexenol, 4-hexenol, cis-3-hexenylhydrocinnamyl alcohol, 2-hydroxybenzoate, 2-hydroxyacetophenone, 4-hydroxybenzylalcohol, 3-hydroxy-2-butanone, hydroxycitronellal, 4-(4-hydroxy-3-methoxyphenyl)-2-butanone, 2-hydroxy-3 -methyl-2-cyclopenten-1-one, 4-(p-hydroxyphenyl)-2-butanone, 2-hydroxy-3,5,5-trimethyl-2-cyclohexenone, delta-isoascorbic acid, isoborneol, isoeugenol, isophytol, isopropyl alcohol, p-isopropylbenzyl alcohol, 4-isopropylcyclohexanol, 3-isopropylphenol, 4-isopropylphenol, 2-isopropylphenol, isopulegol, lauryl alcohol, linalool, maltol, menthol, 4-methoxybenzyl alcohol, 2-methoxy-4-methylphenol, 2-methoxy-4-propylphenol, 2-methoxy-4-vinylphenol, alpha-methylbenzyl alcohol, 2-methylbutanol, 3-methyl-2-butanol, 3-methyl-2-buten-1-ol, 2-methyl-3-buten-2-ol, methyl 2,4-dihydroxy-3,6-dimethylbenzoate, 4-methyl-2,6-dimethoxyphenol, methyl N-3,7-dimethyl-7-hydroxyoctylideneanthranilate, methyl-3-hydroxyhexanoate, 6-methyl-5-hepten-2-ol, 2-methylpentanol, 3-methyl-3-pentanol, 2-methyl-4-phenylbutan-2-ol, 2-methyl-3-phenylpropan-2-ol, methyl salicylate, 3-methyl-5-(2,2,3 -trimethyl-3-cyclopenten-1-yl)-4-penten-2-ol, 2-methyl-2-vinyl-5-(1-hydroxy-1-methyl ethyl)-3,4-dihydrofuran, myrtenol, neohesperidin dihydrochalcone, neomenthol, nerol, nerolidol, trans-2-cis-6-nonadienol, 1,3-nonanediolacetate, nonadyl, 2-nonanol, cis-6-nonen-1-ol, trans-2-nonen-1-ol, nonyl alcohol, 1-octanol, 2-octanol, 3-octanol, cis-3-octen-1-ol, cis-2-octen-1-ol, trans-2-octen-1-ol, cis-6-octen-1-ol, cis-octen-1-ol, 1-octen-3-ol, oleyl alcohol, patchouli alcohol, 3-pentanol, n-pentanol, 2-pentanol, 1-penten-1-ol, cis-2-penten-1-ol, perillyl alcohol, 2-phenoxyethanol arabinogalactan, beta-phenethyl alcohol, phenethyl salicylate, phenol, phenylacetaldehyde glyceryl acetal, 3-phenyl-1-pentanol, 5-phenyl-1-pentanol, 1-phenyl-1-pentanol, 1-phenyl-2-pentanol, 1-phenyl-3-methyl-1-pentanol, phytol, pinacol, polyalkylene glycol, Polysorbate 20, Polysorbate 60, Polysorbate 80, prenol, n-propanol, propenyl guaethol, propylene glycol, 2-propylphenol, 4-propylphenol, resorcinol, retinol, salicylaldehyde, sorbitan monostearate, sorbitol, stearyl alcohol, syringe aldehyde, alpha-terpineol, tetrahydrogeraniol, tetrahydrolinalool, tetrahydromyrcenol, thymol, triethyl citrate, 1,2,6-trihydroxyhexane, p-alpha,alpha-trimethylbenzyl alcohol, 2-(5,5,6-trimethylbicyclo[2.2.1]hept-2-yl cyclohexanol, 5-(2,2,3 -trimethyl-3-cyclopentenyl)-3-methylpentan-2-ol, 3,7,11-trimethyl-2,6,10-dodecatrien-1-ol, 3,7,11-trimethyl-1,6,10-dodecatrien-3 -ol, 3,5,5-trimethyl-1-hexanol, 10-undecen-1-ol, undecyl alcohol, vanillin, o-vanillin, vanillyl butyl ether, 4-vinylphenol, 2,5-xylenol, 2,6-xylenol, 3,5-xylenol, 2,4-xylenol, xylose, 5-(2-methylpropyl)-1-methyl-1-cyclohexene, 1-methylidene-3-(2-methylpropyl)cyclohexane and myrcene.

8. A washing or cleaning agent, containing microcapsules according to claim 1.

9. The washing or cleaning agent according to claim 8, wherein the compound comprises at least one of:
an amount of the microcapsules range from about 0.01 to about 10 wt. % based on the overall agent,
b. an anionic surfactant, a cationic surfactant, a nonionic surfactant, a zwitterionic surfactant, an amphoteric surfactant, and mixtures thereof,
the microcapsules are present in liquid or solid form; and
d. combinations thereof.

10. An air-care agent containing at least one compound from claim 1, wherein the amount of the compound ranges from about 0.01 to about 10 wt. % based on the overall agent.

11. A cosmetic agent containing at least one compound according to claim 1, wherein the compound ranges from about 0.01 to about 10 wt. % based on the overall cosmetic agent.

12. A method for fragrancing surfaces, comprising:
applying the microcapsules of claim 1 to at least one surface to be fragranced; and
heating the microcapsules
a. to a temperature ranging from about 20° C. to about 250° C., and/or
b. bringing the microparticles into contact with a Lewis acid and/or a Bronsted acid.
